(19) United States
(12) Patent Application Publication
(10) Pub. No.: US 2014/0159639 A1
(43) Pub. Date: Jun. 12, 2014

(54) PORTABLE BATTERY CHARGER

(71) Applicants: Garold C. Miller, Glastonbury, CT (US); Nathan Daniel Weinstein, Glastonbury, CT (US)

(72) Inventors: Garold C. Miller, Glastonbury, CT (US); Nathan Daniel Weinstein, Glastonbury, CT (US)

(21) Appl. No.: 14/095,223

(22) Filed: Dec. 3, 2013

Related U.S. Application Data
(60) Provisional application No. 61/732,603, filed on Dec. 3, 2012.

(51) Int. Cl. H02J 7/00

(52) U.S. Cl. CPC H02J 7/0054; H02J 7/0042
USPC 320/103

(57) ABSTRACT

A portable battery charger comprises a power cord having a first end and a second end, with a power input connector interface on the first end of the cord for connection to a power source and a power output connector interface on the second end of the cord for connection to an electronic device needing recharging. A rechargeable battery internally disposed within the power cord is operably connected with the power input connector interface, the power output connector interface, and a power indicator means for indicating the power capacity in the internal battery unit. The battery charger can be combined with an adapter unit or interchangeable adapter pieces on the power input end to interface with various power sources. The battery charger can similarly be combined with an adapter unit or interchangeable adapter pieces on the power output end to interface with various charging connection ports used on electronic devices.

### CROSS REFERENCE TO PRIOR APPLICATION

This application claims the benefit of U.S. Provisional Application No. 61/732,603, filed Dec. 3, 2012, which is incorporated herein by reference.

### FIELD OF INVENTION

The present invention generally relates to chargers for electronic devices, and more particularly relates to a portable battery charger with which a user can charge an electronic device directly from a standard power source, such as a wall socket, a car charger socket, or an airline charger socket, or on-the-go from a portable and rechargeable power source.

### BACKGROUND OF THE INVENTION

Present day consumers typically own several electronic devices specifically designed for portability and on-the-go use, including, for example, a mobile phone or smart phone, a portable music player like an iPod® or an MP3 player, a tablet like an iPad®, a portable gaming unit, a digital camera or camcorder, and the like. Each of these devices requires frequent recharging. Such electronic devices typically utilize a power cord or cable for connecting the device to a power source, such as a wall outlet, a car charger, an airplane charger, or a computer. However, a separate cable is usually required for each power source. Moreover, during recharging, the device must remain attached to the power source via the cable, which makes on-the-go use of the device difficult, as the user is tethered to one spot. When the device is disconnected from the power source or the cable, charging stops. This can be inconvenient if the device has not been sufficiently recharged for intended use away from a power source.

For example, when a phone is plugged into a car charger socket (e.g., a cigarette lighter socket) for recharging, the phone usually can still be used to make and receive calls. However, if the user wants or needs to disconnect the phone from the car charger socket for any reason—e.g., to take a call outside the car, to check a text message, search for directions, or if the user has reached her destination—without feeling tethered to one spot, the phone will stop charging. Additionally, once the car engine is turned off, the phone may stop charging. In either of these situations, the phone battery may not have been charged sufficiently such that a call may be lost or the phone cannot be used sufficiently for intended functions when it is separated from a power source.

Additionally, different electronic devices often utilize different connection ports and interfaces such that a single power cord is not compatible with multiple power sources or multiple electronic devices. Accordingly, a tech-savvy consumer, with several electronic devices, will usually have multiple power cords to keep track of for charging all the devices. Even then, the consumer may not always be in a place where a standard power source is readily available, or even if so, may not have the appropriate power cord or adapter available to use with a particular power source or electronic device.

Multi-source adapters are also available on the market for making a power cord compatible with multiple power sources. For example, a power cord with a traditional plug interface for connecting an electronic device to a wall outlet for recharging could exchange the plug with a car charger interface, or an airplane charger interface, or a standard USB interface. However, for such adapter devices, each of the power interfaces is usually a separate piece, and therefore difficult to keep track of when not in use, or, if stored away, may not be readily available when needed.

Power cords currently on the market are also often very bulky, especially if they have long cables to increase the reach of the power cord during charging. Even then, such prior art power cords typically only function to connect a device to a power source, providing no assistance for on-the-go recharging absent a separate portable power source or once disconnected from a power source.

In view of the foregoing, there is a need for a portable battery charger that can be used to charge a variety of electronic devices, including but not limited to smart phones, mobile phones, data tablets, music players, cameras, camcorders, gaming units, e-books, Bluetooth® headsets and earpieces, GPS devices, and the like. Additionally, there is a need for such a battery charger that is portable and easily used in various conditions and locations to charge electronic devices, including but not limited to in a house or office, a car, an airplane, with a computer, or even on-the-go where no standard power source is readily available. Accordingly, it is a general object of the present invention to provide a portable battery charger that improves upon conventional power chargers, power cords and connector cables currently on the market and that overcomes the problems and drawbacks associated with such prior art devices and accessories.

### SUMMARY OF THE INVENTION

In accordance with the present invention, a portable battery charger is provided for charging electronic devices. In general, the battery charger may comprise a portable power cord having a rechargeable battery unit provided therein, a power input interface on one end of the cord and a power output interface on the other end of the cord.

The battery charger can be combined with an adapter unit on the power input end to interface with various power sources, including U.S. and foreign wall sockets of varying designs, a car charger socket, an airline charger socket, and a USB interface. Alternatively, the power input end of the cord itself can include multiple input connectors, each capable of attachment to a different power source, thereby eliminating the need for separate adapter pieces.

The battery charger can similarly be combined with an adapter unit on the power output end to interface with various charging interfaces used on electronic devices, including a USB interface, a micro-USB interface, a mini-USB interface, an AC/DC interface, and the like. The adapter unit can comprise interchangeable parts, each adaptable to a different type of connection interface, or alternatively, include several different connection interfaces on the same part—e.g., a squid connector with multiple connectors.

The power cord can further include a USB connection port for connecting additional devices to the portable battery charger for recharging or data exchange, without departing from the principles and spirit of the present invention.

In a first aspect of the present invention, the portable battery charger comprises a power cord having a first end and a second end, with a power input connector interface on the first end of the cord for connection to a power source and a power output connector interface on the second end of the cord for connection to an electronic device needing recharging. A rechargeable battery internally disposed within the cord is operably connected with the power input connector interface and the power output connector interface.

In one embodiment of the present invention, the power input connector interface is adaptable for use with a standard U.S. wall socket.

In another embodiment of the present invention, the power input connector interface is adaptable for use with a standard car charger socket—e.g., a cigarette lighter socket.

In another embodiment of the present invention, the power input connector interface is adaptable for use with a standard airline charger socket.

In another embodiment of the present invention, the power input connector interface is adaptable for use with a USB port, for example, provided on a personal computer.

In additional embodiments of the present invention, the power input connector interface is adaptable for use with foreign wall sockets of various designs.

Still further, the present invention can utilize a design that permits interchanging of power input connector adapters for use with a variety of standard power sources, including those mentioned above. Alternatively, the power input end of the power cord could be provided with a single multi-use power input adapter or a fixed power input connector interface that includes interfaces for two or more power sources. In a preferred embodiment of the present invention, the power input end of the cord comprises a multi-functional interface that permits connection to a standard U.S. wall socket, a car charger socket and an airline charger socket, as necessary.

In another aspect of the present invention, a portable battery charger may further comprise a processing unit contained within the power cord, which can keep track of the capacity level of the rechargeable battery unit disposed therein, store data or provide a conduit means by which data can be exchanged between electronic devices, such as between a smart phone and a computer.

In another aspect of the present invention, a power interface is provided on the power cord to indicate the power level of the internal rechargeable battery unit. The power interface can comprise a light or series of lights, a digital readout, or other known forms of indicating power level of a battery. Additional indicator means can be utilized in the present invention for various functionalities, including but not limited to indicating that a charge is being provided to an electronic device, either from a standard power source or the internal battery unit of the portable battery charger, or indicating the power level in an electronic device attached to the charger via the power output connector interface.

These and other objects, features and advantages of the present invention will become apparent in light of the detailed description of embodiments thereof, as illustrated in the accompanying drawings.

### BRIEF DESCRIPTION OF THE DRAWINGS

FIG. 1 shows a perspective view of a portable battery charger in accordance with a first embodiment of the present invention.

FIG. 2 shows a perspective view of a portable battery charger in accordance with a second embodiment of the present invention.

FIG. 3 shows a perspective view of a portable battery charger in accordance with a third embodiment of the present invention.

FIG. 4 shows a perspective view of a portable battery charger in accordance with a fourth embodiment of the present invention.

FIG. 5 shows a perspective view of a portable battery charger in accordance with a fifth embodiment of the present invention.

FIG. 6 shows a perspective view of a portable battery charger in accordance with a sixth embodiment of the present invention.

FIG. 7 illustrates a schematic view of internal components of the charger unit of FIG. 1.

FIG. 8 shows a perspective view of a portable battery charger in accordance with a seventh embodiment of the present invention.

FIG. 9 illustrates a planar side view of the portable battery charger of FIG. 8 in a first set-up condition.

FIG. 10 illustrates a planar side view of the portable battery charger of FIG. 8 in a second set-up condition.

FIG. 11 illustrates a planar side view of the portable battery charger of FIG. 8 in a third set-up condition.

### DETAILED DESCRIPTION OF THE DRAWINGS

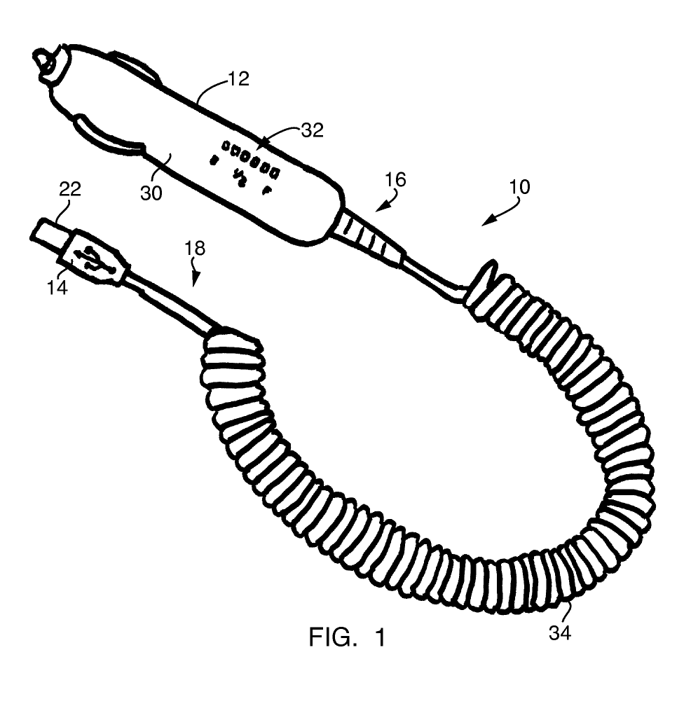

A portable battery charger in accordance with the present invention is shown in FIG. 1, and generally comprises a portable power cord generally designated as reference numeral 10 having a rechargeable battery unit provided therein, a power input interface 12 on one end of the cord 10 and a power output interface 14 on the other end of the cord 10. In accordance with the present invention, the power cord 10 can be combined with an adapter unit on the power input end 12 to interface with various power sources, including U.S. and foreign wall sockets of varying designs, a car charger socket, an airline charger socket, and a USB interface, such as the adapter unit described and illustrated in co-pending U.S. application Ser. No. 13/571,992, filed Aug. 10, 2012, which shares common inventors with the present application and which is incorporated herein by reference. Alternatively, the power input end 12 of the power cord 10 can collectively comprise multiple input connectors, or be used with a singular adapter unit comprising multiple input connectors, each capable of attachment to a different power source, thereby eliminating the need for separate and loose adapter pieces.

The power cord 10 can similarly be combined with an adapter unit on the power output end 14 to interface with various charging interfaces used on electronic devices, including for example a USB interface, a mini-USB interface, a micro-USB interface, an AC/DC interface, and the like. Such an output adapter unit can comprise interchangeable pieces, each adaptable to a different type of interface, or alternatively, the portable power cord 10 can include an output end 14 collectively comprising multiple different interfaces or be adapted for use with an adapter comprising multiple different interfaces on the same part—e.g., a squid connector with multiple connectors.

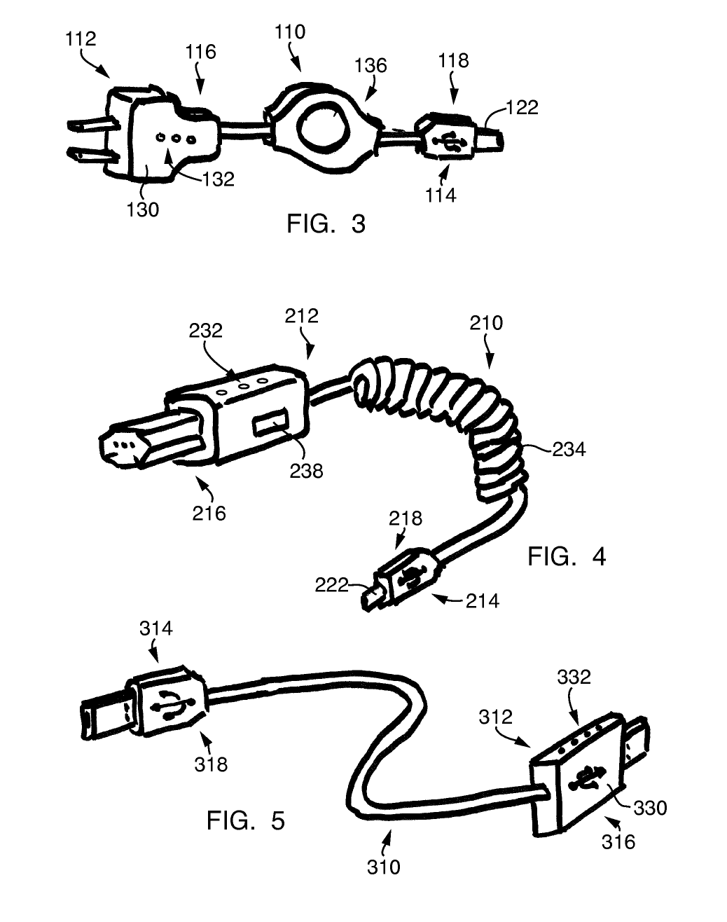

As illustrated in FIG. 1, the portable battery charger comprises a power cord 10 having a first end 16 and a second end 18, with a power input connector interface 12 on the first end 16 of the cord 10 for connection to a power source and a power output connector interface 14 on the second end 18 of the cord 10 for connection to an electronic device needing recharging. A rechargeable battery, designated in FIG. 1 by reference numeral 20, is internally disposed within the cord 10 and operatively connected with the power input connector interface 12 and the power output connector interface 14. The cord 10 can have a coiled portion 34 or include a retractor (FIG. 3) so as to reduce the overall size of the portable battery charger without compromising the usable reach or flexibility of the cord 10 when connected to a power source.

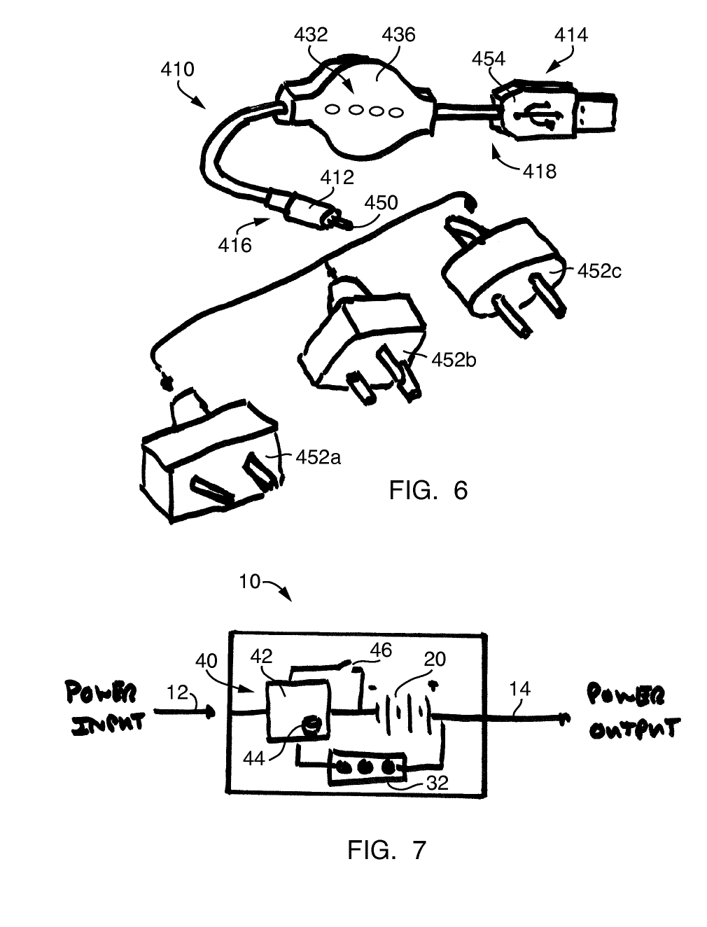

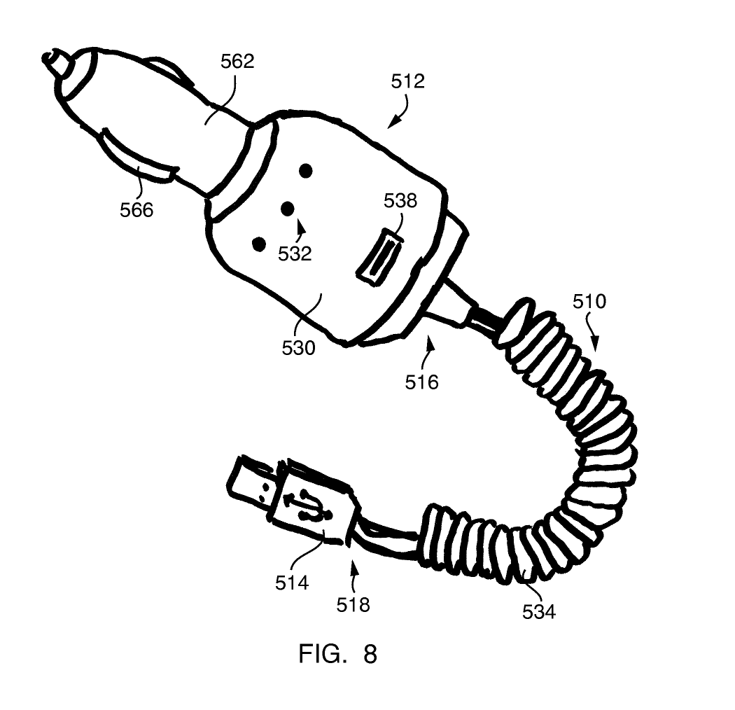

As illustrated, the power input connector interface 12 is adapted for connection to a standard car charger socket—e.g., a cigarette lighter socket. In alternate embodiments of the present invention, the power input connector interface can be adapted for connection to a standard U.S. wall socket (FIG. 3), a standard airline charger socket (FIG. 4), a USB port, for example, provided on a personal computer (FIG. 5), or foreign wall sockets of various designs (FIG. 6). Still further, the present invention can utilize a design that permits interchanging of power input connector adapter pieces for use with a variety of standard power sources, including those mentioned above, by simply changing out the power input connector interface to adapt to whatever power source is available at a particular time. For example, the power input end 12 of the power cord 10 could include a USB interface, such as shown in FIG. 5, which can connect the power charger to a desired adapter for use with any complementary external power source. Alternatively, the power input end 12 of the power cord 10 could be provided with a single, multi-functional power input adapter or a fixed power input connector interface that includes interfaces for two or more power sources, such as the design shown in FIG. 8, wherein the power input end 12 of the cord 10 comprises an interface that permits connection to a standard U.S. wall socket, a car charger socket, an airline charger socket, and a computer, as necessary.

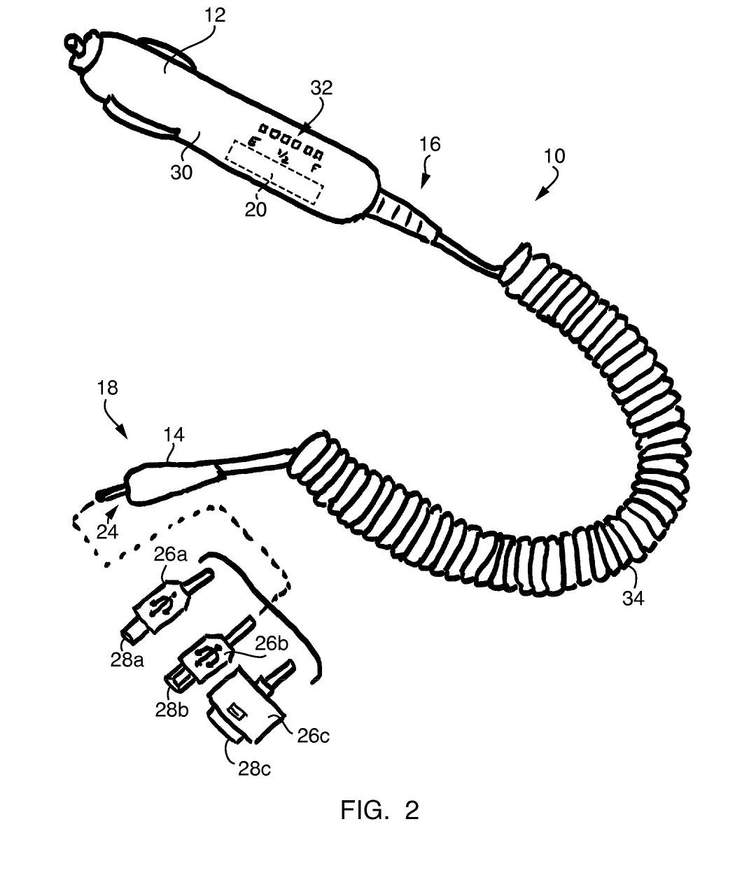

As illustrated in FIG. 1, the power output connector interface 14 comprises a standard mini-USB connector 22, commonly used with many mobile phone and smart phone models on the market. As noted, the power output end 14 of the power cord 10 can comprise various interface connector designs, utilize interchangeable connector adapter pieces, each adaptable to a different type of interface, or comprise multiple different interfaces usable as necessary (such as a squid connector). As shown in FIG. 2, the second end 18 of the power cord 10 may comprise a coaxial interface 24 designed for receiving adapter pieces 26, each having a different interface 28 designed for connection with various electronic devices. For example, the first adapter piece 26a shown in FIG. 2 comprises a micro-USB interface 28a, the second adapter piece 26b comprises a mini-USB interface 28b, and the third adapter piece 26c comprises 30-pin interface 28c. Where the power output end 14 of the power cord 10 comprises multiple different interfaces, the portable battery charger can be used to charge multiple electronic devices at the same time, either directly from a standard power source, or from the internal rechargeable battery unit 20 disposed within the power cord 10.

In preferred embodiments of the present invention, the rechargeable battery unit 20 is disposed within the power input end 12 of the cord 10—for example, within a car charger interface housing 30 illustrated in FIG. 1. As illustrated in FIG. 7, the rechargeable battery unit 20 is operatively connected with the power input connector interface 12 for recharging the battery 20 when the power cord 10 is connected to an external power source. The rechargeable battery 20 is also operatively connected with the power output connector interface 14 for recharging electronic devices connected to the power cord 10 from the rechargeable battery unit 20. In preferred embodiments, the battery unit 20 comprises a Lithium-Ion battery.

The power cord 10 also encloses various electrical components (such as integrated circuit chips and other circuitry) to provide computing operations for the device. The integrated circuitry and other components may comprise a power supply (e.g., the internal rechargeable battery), a microprocessor and controller (e.g., a CPU), memory (e.g., ROM, RAM, flash), a circuit board, a hard drive, and/or various input/output (I/O) support circuitry. The electrical components may also include components for sending and receiving data and media (e.g., antenna, receiver, transmitter, transceiver, etc.).

As illustrated in FIG. 7, the power cord 10 comprises a controller 40, including a processing unit 42, configured to execute instructions and to carry out operations associated with the power cord 10. For example, the processing unit 42 can keep track of the capacity level of the battery unit 20, store data or provide a conduit means by which data can be exchanged between electronic devices, such as between a smart phone and a computer. The processing unit 42 communicates with the battery unit 20 to determine how much capacity is remaining in the battery. Upon determining the capacity level, the processing unit 42 can communicate with a power indicator means 32 to provide the user with information for how much capacity is remaining in the internal rechargeable battery unit 20.

The processing unit 42 also includes a smart interface to determine the total current required for specific devices connected to the power cord 10. In this regard, the processing unit 42 operates in connection with input/output (I/O) support circuitry to control interactions with devices connected to the power cord 10. The I/O support circuitry may be integrated with the processing unit 42 or may be a separate component. Generally, the I/O support circuitry operates by exchanging power (and possibly data) between the power cord 10 and electronic devices connected thereto via the power output connector interface 14.

The processing unit 42 further includes a storage unit 44 that provides a place to hold data or instructions for operation of the power cord 10 and rechargeable battery unit 20, or data exchanged between the power cord 10, a computer, and electronic devices connected to the power cord 10, or memory needed for further operations of the power cord 10.

The power cord 10 can further include a USB interface (FIG. 4) for connecting additional devices to the portable battery charger for recharging or data exchange, without departing from the principles and spirit of the present invention.

The power cord 10 is readily portable as a result of the small size and increased flexibility of the coiled power cord 10 illustrated in FIGS. 1-2. Alternately, the size of the power cord 10 can be kept compact while allowing a long reach for use—either when connected to an electronic device for use or when tethered to an external power source for recharging itself—by using a retractor, such as illustrated in FIG. 3. Despite the small size of the power cord in accordance with the various embodiments described and shown herein, the power capacity is very high so that the rechargeable internal battery unit 20 can accommodate multiple electronic devices at the same time, if necessary.

In accordance with intended operation of the portable power cord 10, a user can recharge one or more electronic devices using the internal rechargeable battery unit 20, a computer, a wall socket, a car power socket, or an airplane power socket. For example, the portable power cord 10 of the present invention can be used to charge smart phones, mobile phones, data tablets, music players, cameras, camcorders, gaming units, e-books, Bluetooth® headsets and earpieces, GPS devices, and the like. In operation, the rechargeable battery unit 20 can be recharged by connecting the power cord 10 to an external power source, such as a computer, a wall socket, a car or an airplane, using the power input connecter interface 12. At the same time, an electronic device can be connected to the other end of the power cord 10 via the power output connector interface 14. When the power cord 10 is connected to an external power source, the electronic device will be recharged directly from the external power source. This can be done at the same time as when the rechargeable battery unit 20 inside the power cord 10 is being recharged. When the power cord 10 is disconnected from the external power source, the rechargeable battery unit 20 can be used to recharge an electronic device connected to the power output interface 14 of the charger, which is especially useful for on-the-go use of an electronic device, or when the user needs to recharge an electronic device where no external power source is readily accessible.

Referring again to FIG. 1, the portable power cord 10 also includes a power indicator means 32 that will indicate not only that an electrical current is being supplied to an electronic device connected to the power output connector interface 14, but also the remaining capacity of the internal rechargeable battery unit 20 in the power cord 10. For example, in an embodiment of the present invention, the power indicator means 32 comprises a series of six lights, but can include more or fewer lights without departing from the principles and spirit of the present invention. In operation, when the battery is at full capacity, all the lights will be lit up. As the battery power decreases, the lights will correspondingly decrease by one as the power is used. If there is no capacity left in the internal battery, none of the lights will be lit up. Additionally or alternatively, the power indicator means 32 can include informative descriptors—e.g., “F” designating “full,” “½” designating half capacity, and “E” designated “empty”—or can comprise a digital interface that provides a battery capacity level for the internal rechargeable battery unit, or another known means of providing battery level information.

The processing unit 42 of the power cord 10, which can keep track of the capacity level of the internal rechargeable battery unit 20, store data or provide a conduit means by which data can be exchanged between electronic devices, such as between a smart phone and a computer, communicates with the battery unit 20 to determine how much capacity is remaining in the battery 20. Upon determining the capacity level, the processing unit 42 communicates with the power indicator means 32 to provide the user with the appropriate signal for showing how much capacity is remaining in the internal battery 20.

The processing unit 42 may also includes a smart interface to determine the total current required for the specific electronic devices connected to the battery charger. Additionally, the battery charger may comprise an internal switch 46 to draw power from the rechargeable battery unit 20 or essentially turn off the battery unit 20. For example, the processing unit 42 can determine if the power cord 10 is connected to an external power source. If so, when an electronic device is also connected to the power cord 10, the processing unit 42 can ensure that the electronic device is being charged directly from the external power source instead of drawing power from the rechargeable battery unit 20 as it is being recharged itself. Further, the processing unit 42 can determine when the power cord 10 is disconnected from an external power source, and, if still connected to an electronic device, sufficiently switch the internal circuitry of the battery charger so that the electronic device continues to be recharged from the rechargeable battery unit 20 without delay.

The processing unit 42 also preferably includes a timer for automatically turning the battery charger off if there is no device attached to the power cord 10 for a predetermined period of time, or if any device still attached to the power cord 10 has reached maximum capacity. In this regard, the capacity of the internal rechargeable battery unit 20 in the power cord 10 can be preserved. Upon shut down of the power cord 10, the power indicator means 32 will indicate that the power cord 10 is being turned off—for example, the lights will provide a sequential blinking signal.

Additional indicator means can be utilized in the present invention for various functionalities, including but not limited to indicating that a charge is being provided to an electronic device, either from a standard external power source or from the internal rechargeable battery unit 20 of the portable power cord 10, or indicating the power level in an electronic device attached to the power cord 10 via the power output connector interface 14.

In accordance with another feature of the present invention, the portable power cord 10 can be used as a conduit by which data can be exchanged between electronic devices and a portable computer or an external storage database.

Additional embodiments of a portable battery charger in accordance with the present invention are illustrated in FIGS. 3-6 and 8-11. These embodiments of portable battery chargers utilize similar features as shown and described with reference to the chargers shown in FIGS. 1-2, such as a power cord, a power input interface, a power output interface, and power indicator means, and therefore designate such similar features by like reference numerals with different prefatory numbers.

FIG. 3 shows a portable battery charger comprising a power cord 110 having a first end 116 and a second end 118, with a power input connector interface 112 in the form of a standard wall plug on the first end 116 for connection with a wall socket and a power output connector interface 114 on the second end 118 for connection to an electronic device needing recharging. For illustration purposes, the power output connector interface 114 comprises a standard mini-USB connector 122, but can comprise various interface connector designs, or utilize interchangeable connector adapter pieces, without departing from the spirit and principles of the present invention. In accordance with the present invention, a rechargeable battery unit 120 is internally disposed within the cord 110, preferably, within the housing 130 of the power input interface 112, and is operatively connected with the power input connector interface 112, the power output connector interface 114, and power indicator means 132. As illustrated, the power indicator means 132 is also provided on the housing 130 of the power input connector interface 112. The cord 110 further includes a retractor 136 to reduce the overall length of the cord 110 without compromising the usable reach or flexibility of the cord 110 when connected to a power source.

FIG. 4 shows a portable battery charger comprising a power cord 210 having a first end 216 and a second end 218, with a power input connector interface 212 in the form of an airplane charger interface on the first end 216 for connection with an airplane charger socket and a power output connector interface 214 on the second end 218 for connection to an electronic device needing recharging. For illustration purposes, the power output connector interface 214 comprises a standard mini-USB connector 222, but can comprise various interface connector designs, or utilize interchangeable connector adapter pieces, without departing from the spirit and principles of the present invention. In accordance with the present invention, a rechargeable battery unit 220 is internally disposed within the cord 210, preferably, within the housing 230 of the power input interface 212, and is operatively connected with the power input connector interface 212, the power output connector interface 214, and power indicator means 232. As illustrated, the power indicator means 232 is also provided on the housing 230 of the power input connector interface 212. The cord 210 is coiled (coiled portion 234) to reduce the overall length of the cord 210 without compromising the usable reach or flexibility of the cord 210 when connected to a power source. As illustrated in FIG. 4, the housing 230 of the power input connector interface 212 can further include a USB port 238 for connection to additional devices via a standard USB charging cable.

FIG. 5 shows a portable battery charger comprising a power cord 310 having a first end 316 and a second end 318, with a power input connector interface 312 on the first end 316 for connection with an external power source and a power output connector interface 314 on the second end 318 for connection to an electronic device needing recharging. For illustration purposes, both the power input connector interface 312 and the power output connector interface 314 comprise a standard USB interface for connection with a complementary USB connection port—either on an external power source (e.g., a computer), and electronic device in need of recharging, or on an appropriate adapter (as illustrated elsewhere herein). The connector interfaces can comprise various interface connector designs, or utilize interchangeable connector adapter pieces, without departing from the spirit and principles of the present invention. In accordance with the present invention, a rechargeable battery unit 320 is internally disposed within the cord 310, preferably, within the housing 330 of the power input interface 312, and is operatively connected with the power input connector interface 312, the power output connector interface 314, and power indicator means 332. As illustrated, the power indicator means 332 is also provided on the housing 330 of the power input connector interface 312. Though not illustrated, the cord 310 could further be coiled or include a retractor to reduce the overall length of the cord 310 without compromising the usable reach or flexibility of the cord 310 when connected to a power source.

FIG. 6 shows a portable battery charger comprising a power cord 410 having a first end 416 and a second end 418, with a power input connector interface 412 on the first end 416 for connection with an external power source and a power output connector interface 414 on the second end 418 for connection to an electronic device needing recharging. The power input connector interface 412 illustrated in FIG. 6 comprises a coaxial interface 450 designed for receiving adapter pieces 452, each having a different interface designed for connection with different foreign power sockets. For illustration purposes, the power output connector interface 414 comprises a standard USB interface, but can comprise various interface connector designs, or utilize interchangeable connector adapter pieces, without departing from the spirit and principles of the present invention. In accordance with the present invention, a rechargeable battery unit 420 is internally disposed within the cord 410, preferably in this case, within the housing 454 of the power output interface 414, and is operatively connected with the power input connector interface 412, the power output connector interface 414, and power indicator means 432. The cord 410 further includes a retractor 436 to reduce the overall length of the cord 410 without compromising the usable reach or flexibility of the cord 410 when connected to a power source. As illustrated, the power indicator means 432 is provided on the retractor housing 436.

Another alternate embodiment of a portable battery charger in accordance with the present invention is shown in FIGS. 8-11, and generally comprises a power cord generally designated by reference numeral 510. As illustrated, the power input end 516 of the power cord 510 comprises an all-in-one, multi-function connector interface 512 for connecting the power cord 510 and any electronic device connected thereto to a variety of standard power sources, such as a standard U.S. wall socket, a car charger socket, an airplane charger socket, or a computer, where available or necessary. As shown, the power input connector interface 512 comprises a main housing 530 having multiple interfaces for connecting the power cord 510 or another electronic device attached to the power cord 510 to a power source. A similar adapter design is illustrated in co-pending U.S. application Ser. No. 13/571,992, which has common inventors herewith and which is incorporated herein by reference. In a preferred design, such an interface provides an all-in-one charger adapter, with a plug interface 560 for connection with a standard wall socket, a car charger interface 562 for connection with a car charger socket, and an airplane charger interface 564 for connection with an airplane charger socket. The input connector interface 512 may further include a USB port 538 for connection to another power source, such as a computer, via a USB connector cable.

In an embodiment of this power charger concept, as illustrated in FIG. 11, the airplane charger interface 564 is disposed within a removable car charger interface 562, whereby the latter interface can be removed to expose the former interface for use. In this regards, the power input interface 512 can be designed with a compact, all-in-one design, which is advantageous for storage and travel. As illustrated, the car charger interface 562 includes contacts 566 in accordance with standard car charger designs for providing a current from the power source through the interface. The car charger contacts 566 are internally operatively connected with contacts (not shown) on the airplane charger interface 564 so that the current is provided through the interface to the power cord 510 uninterrupted. When the car charger interface 562 is removed, the airplane contacts are exposed for connection to an airplane power socket.

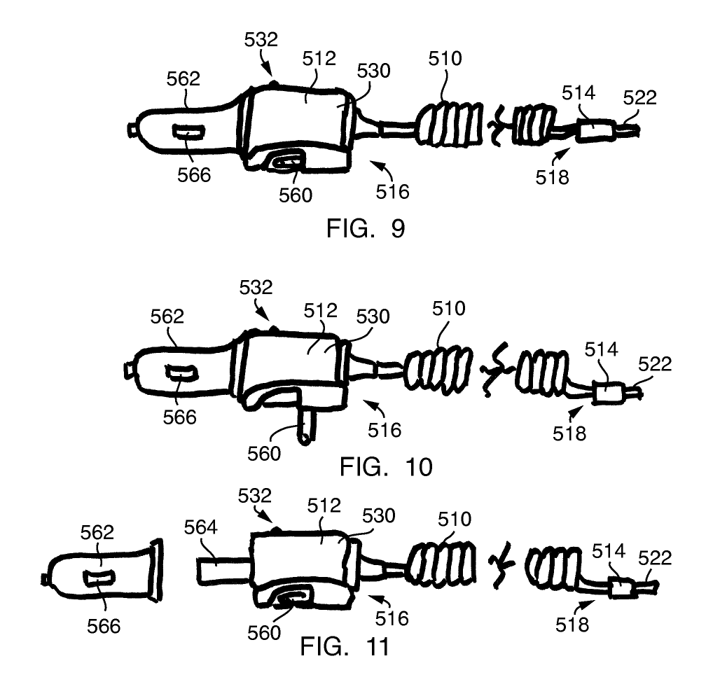

Additionally, the plug interface 560 is designed to fold within the footprint of the main housing 530 for storage when not in use or needed and folded out to project from the main housing 530 when needed to plug the power charger into a wall socket, as illustrated in FIGS. 9-10.

Additional connector interfaces can be used, such as foreign wall plugs of various designs, or a male USB connector, without departing from the spirit and principles of the present invention.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A portable power cord for recharging at least one electronic device having a rechargeable internal battery, said power cord having a first end and a second end and further comprising:
a power input connector interface on the first end of the power cord for connection to an external power source;
a power output connector interface on the second end of the power cord for connection to at least one electronic device; and
a rechargeable battery unit internally disposed within the power cord that is operably connected with the power input connector interface and the power output connector interface.

2. The portable power cord according to claim 1, wherein the power input connector interface is adapted for use with one of a wall socket, a car charger socket, an airplane charger socket and a USB connection port.

3. The portable power cord according to claim 1, further comprising an adapter unit, wherein the power input connector interface is adapted to connect with the adapter unit for connecting the power cord to an external power source.

4. The portable power cord according to claim 3, wherein the adapter unit is adapted for use with at least one of a wall socket, a car charger socket, an airplane charger socket and a USB connection port.

5. The portable power cord according to claim 4, wherein the adapter unit comprises a wall plug interface and a car charger interface.

6. The portable power cord according to claim 4, wherein the adapter unit comprises a wall plug interface, a car charger interface, and an airplane charger interface.

7. The portable power cord according to claim 1, further comprising interchangeable power input connector adapter pieces attachable to the power input connector interface, each capable of connecting with a different power source and comprising a distinct one of a wall socket, a car charger socket, an airplane charger socket and a USB connection port.

8. The portable power cord according to claim 1, further comprising interchangeable power output connector adapter pieces attachable to the power output connector interface, each capable of connecting with a different power connection port.

9. The portable power cord according to claim 1, further comprising power indicator means operatively connected with the internal battery unit for indicating at least one of the power capacity of the battery unit of the power cord and the power capacity of an electronic device connected to the power cord via said power output connector interface.

10. The portable power cord according to claim 1 wherein the power cord is coiled between the first and second ends.

11. The portable power cord according to claim 1 further comprising a retractor positioned between the first and second ends of the power cord for reducing the length of the power cord.

12. A portable power cord for recharging at least one electronic device having a rechargeable internal battery, said power cord having a first end and a second end and further comprising:
a power input connector interface on the first end of the power cord for connection to an external power source, said power input connector interface comprising a housing having at least two connection interfaces adapted to connect to distinct power sources;
a power output connector interface on the second end of the power cord for connection to at least one electronic device; and
a rechargeable battery unit internally disposed within the power cord that is operably connected with the power input connector interface and the power output connector interface.

13. The portable power cord according to claim 12, wherein the power input connector interface includes at least two of a wall plug interface, a car charger interface, an airplane charger interface, a USB connection interface, and a USB connection port.

14. The portable power cord according to claim 12, further comprising power indicator means operatively connected with the internal battery unit for indicating at least one of the power capacity of the battery unit of the power cord and the power capacity of an electronic device connected to the power cord via said power output connector interface.

15. The portable power cord according to claim 12 wherein the power cord is coiled between the first and second ends.

16. The portable power cord according to claim 12 further comprising a retractor positioned between the first and second ends of the power cord for reducing the length of the power cord.

17. A portable power cord for recharging at least one electronic device having a rechargeable internal battery, said power cord having a first end and a second end and further comprising:
a power input connector interface on the first end of the power cord for connection to an external power source;
a power output connector interface on the second end of the power cord adaptable for connection to at least one electronic device;
interchangeable power output connector adapter pieces attachable to the power output connector interface, each capable of connecting with a different power connection port; and
a rechargeable battery unit internally disposed within the power cord that is operably connected with the power input connector interface and the power output connector interface.

18. The portable power cord according to claim 17, wherein the power input connector interface is adapted for use with one of a wall socket, a car charger socket, an airplane charger socket and a USB connection port.

19. The portable power cord according to claim 17, further comprising an adapter unit, wherein the power input connector interface is adapted to connect with the adapter unit for connecting the power cord to an external power source.

20. The portable power cord according to claim 19, wherein the adapter unit is adapted for use with at least one of a wall socket, a car charger socket, an airplane charger socket and a USB connection port.

21. The portable power cord according to claim 17, further comprising interchangeable power input connector adapter pieces attachable to the power input connector interface, each capable of connecting with a different power source and comprising a distinct one of a wall socket, a car charger socket, an airplane charger socket and a USB connection port.

22. The portable power cord according to claim 17, further comprising power indicator means operatively connected with the internal battery unit for indicating at least one of the power capacity of the battery unit of the power cord and the power capacity of an electronic device connected to the power cord via said power output connector interface.

23. The portable power cord according to claim 17 wherein the power cord is coiled between the first and second ends.

24. The portable power cord according to claim 17 further comprising a retractor positioned between the first and second ends of the power cord for reducing the length of the power cord.
